(19) United States
(12) Patent Application Publication
(10) Pub. No.: US 2005/0129186 A1
(43) Pub. Date: Jun. 16, 2005

(54) Audio recording system

(76) Inventors: Amiel Dabush-Dorel, Weston, CT (US); Shlomo Shur, Fairfield, CT (US); Yaron Ram, Fairfield, CT (US)

Correspondence Address: ST. ONGE STEWARD JOHNSTON & REENS, LLC, 986 BEDFORD STREET, STAMFORD, CT, 06905-5619, US

(21) Appl. No.: 11/004,469

(22) Filed: Dec. 3, 2004

Related U.S. Application Data
(60) Provisional application No. 60/526,615, filed on Dec. 3, 2003.

(51) Int. Cl. H04M 1/64

(52) U.S. Cl. 379/67.1; 369/83; 360/1

(57) ABSTRACT

An audio data recording system for recording, transmitting, storing and manipulating analog audio data. The audio data recording system providing for connection to a telephone and a telephone earpiece, and further to a computer via, for instance, a USB connection for recording analog audio data, converting the analog audio data to digital audio data and transmitting the digital audio data to the computer for storage and/or further manipulation. The audio data recording system further presenting the stored files in the form of a list and providing a user with the option to append comments to the files and various locations within the files.

### FIELD OF THE INVENTION

The invention relates to an audio recording system, and more specifically to a software and hardware package used to record audio data picked up from a telephone and/or from an ambient environment which audio data is fed into a computer.

### BACKGROUND OF THE INVENTION

The need to record audio data such as a conversation on a phone, has become increasingly important for legal purposes, security reasons, and for documentation reasons. However, while voice recording systems have been in use for some time, the present voice recording systems are limited in their ability to transfer, sort, and manipulate the recordings.

Computers systems however, provide the ability to store and manipulate vast amounts of data in a short period of time. Again, while computers have been utilized in many data transferring applications, present voice recording systems fail to provide the ability to manipulate the recordings or provide adequate sorting features. Therefore, an audio recording system that may be used in connection with a computer system to take advantage of the data processing capabilities of the computer system is greatly desired.

In many instances it is desirable to append additional information to a particular recording that may be related to or may help to cross-reference the information to another recording, or that may facilitate further manipulation, transferring or filing of the recording.

It is further desired then, to provide an audio recording system that facilitates ease of manipulation, sorting, storing and transferring of the audio recordings.

It is still further desired to provide a recording system that facilitates the appending of comments and/or notes to audio recording.

Still further, in many instances, it is desired to have an audio recording system that is small in size, and virtually maintenance-free. For instance, many existing voice recording systems provide power for the system via batteries or through an electrical connection with a cable. Batteries however must be changed over time and it may be undesirable in certain circumstances to have to run an electrical cable to the audio recording device depending upon the location of the device and the application.

It is yet further desired then to provide an audio recording system that is light-weight and does not require the use of batteries or a power cord to provide power to the recorder itself.

### SUMMARY OF THE INVENTION

The audio data recording system according to the present invention is configured to achieve these desired objectives. In one advantageous embodiment the audio data recording system may comprise, a hardware and software system for digital recording and storage of audio data to a computer through the Universal Serial Bus (USB) connection. The audio data recorder may provide a plurality of inputs for capturing for instance, audio signals. The audio signal may be an analog signal which is converted to a digital signal, compressed and formatted into a standard audio format, and finally transferred through a USB connection to a computer for storage and/or further manipulation. Alternatively, the system may capture a digital signal and convert the digital signal to PCM and wave format. An example of this could be for instance, recording audio on a voice over IP and/or digital key systems. The audio data recording system may also perform the reverse function of taking a formatted digital file, transferring it through the USB connection to the audio data recorder, which in turn converts that to an analog signal that is then played through a handset of the telephone. Alternatively, the audio data recording system may further be utilized to play a recorded digital file through speakers provided with the computer.

In one advantageous embodiment, the audio data recording system comprises hardware in the form of an audio recorder that is connected to for instance, a telephone, the telephone earpiece, to for instance, a USB port located on a computer, and software running on the computer for data manipulation of the recorded audio data. The audio data recording system may be provided with in this embodiment, caller identification.

In one particularly advantageous embodiment, the hardware or audio data recorder does not require use of batteries or an electrical power cord to supply electrical power to the device as electrical power may be provided from the computer through the USB connection.

The audio data recorder may be provided with three jack connections: one for connecting to the computer USB port; the second for connecting to a handset cord of the telephone; and the third for connecting to the telephone itself. The audio data recorder may further provided with an additional Input/Output jack to connect to a standard phone headset if desired. A further configuration is provided allowing the audio data recorder to connect directly to an analog telephone line.

In still another advantageous embodiment, the audio data audio recording system may connect to the computer through the UBS connector. Upon connection and loading the software, the audio data recording system may activate the appropriate driver software to effectively provide the device with a plug-and-play solution.

In yet another advantageous embodiment of the present invention, the audio recorder may comprise LEDs (Light Emitting Diodes) and push switches. One of the LEDs may for instance, indicate when the voice recorder has power applied to it and is on, i.e. when the audio recorder is connected to the USB port of the computer.

The push button switches may be used to operate the audio recorder with the LEDs corresponding to the push button switches. Each will illuminate to show for instance, which switch or function has been activated at any one time.

In one advantageous embodiment, the switches may be used and may comprise the following: (1) Record Room—used to record audio data directly picked up by the device, such as a conversation held in the room the device is located; (2) Record Phone—used to record a telephone conversation; (3) Play/Stop—used to playback a recording; (4) FF/Rewind/Scroll—allows user to review the recording, where the push button may be configured such that for instance, pushing the left side of the button will rewind or pushing the right side of the button will FF and/or scroll the recorded messages.

A microphone is provided in the audio recorder itself that may be used for instance, to record a room conversation. Also provided on the audio recorder is an interface for a headset, which in one advantageous embodiment may comprise a 2.5 mm headset input. It is further contemplated that the Record Room function may further be expanded to record audio data remote to the audio device, such as a conversation in another room or location with the audio feed being sent to the audio recorder. It is further contemplated that it may be desirable to record audio data in multiple remote locations from the audio recording device, which then may be equipped with the ability to select which remote location the user desires to record. It is contemplated that the system may be configured to automatically record audio data based upon voice detection, and/or a room or space may be monitored and automatically recorded and/or set to an event i.e. an alarm at a remote location,

It is still further contemplated that the system may be provided with a mechanism to detect and report the disconnection of for instance, the audio recorder. This may be accomplished by means of for instance, electronic circuitry and/or software that identifies the disconnection of the device from the computer, telephone, the line or any combination thereof. It is further contemplated that upon disconnection an event or alarm may be activated.

The audio data recording system is functional in a “stand alone” mode, in which it is connected directly to the phone and the computer, or in a “hub mode” in which it is connected to a computer hub rather than directly to the computer itself. In the hub mode, a single computer may be connected to multiple individual voice recorders. Recorded files maybe stored in individual user folders on the computer with each voice recorder operating independent from each other. In still another advantageous embodiment, the user may have the ability to record and play multiple audio data files simultaneously.

In yet another advantageous embodiment, the audio data recording system may be used in what is referred to as “enterprise mode” that facilitates a plurality of audio recorders to be connected to a plurality of individually networked computers. The recorded files may be centrally located to the enterprise allowing a system administrator maximum capabilities for reviewing and organizing the recorded information. The system administrator may for instance, search and listen to all recordings by date, time, client, agent, type of call book mark or comments added to the recorded file. A system administration screen further provides the ability to monitor the status of each device. In another advantageous embodiment, the system uses a database, such as an SQL database configuration to track and organize the recorded conversations. A further function that may be provided is the ability to transfer files via software, such as TCP/IP to a central server location. The TCP/IP communication may be used to maintain a real time status of each of the voice recorders within the network.

In still another advantageous embodiment, the audio data recording system allows users more than one interface to the recording device.

In yet another advantageous embodiment, the audio data recording system comprises a three interface element.

The first mode may comprise for instance, an icon mode or a so-called “systray” mode, where the software is minimized to an icon in the icon of the operating system. In the normal wait state the icon may be illustrated as yellow in color. In a record condition the color of the icon may change for instance, to red. While during playback mode the icon may for instance, be shown as green in color.

A second mode may comprise for instance, a so-called “small footprint” mode where the software displays a small interface that gives the user the ability to select record and/or play modes, and record and/or play files with reviewing capabilities.

Still further, a third mode may comprise for instance, a so-called “full size” mode that allows a user to have access to the maximum capabilities of the audio recording system so as to adjust configurations and to review and organize the recordings.

In one configuration, the audio data recording system may be configured to record a conversation from the telephone and play the recording back through the speakers of the computer. In another configuration, the audio data recording system may be configured to record from the microphone attached to either the voice recorder and/or the computer and then play the recording back through the speakers of the computer. The audio data recording system may further be configured to play through the voice recorder which may then allow a user to privately review the recording in the handset of the telephone.

The software may still further allow the user to set comments and bookmarks on the recordings for quick and easy retrieval to specific locations of the recordings. A user whom for instance, is reviewing a recording may create a bookmark that references a specific location within a recording. The user may then be allowed to input a written description for the bookmark.

A comment, like a bookmark, allows the user to reference a specific location within a recording but allows the user more space to describe the comment. The software allows a caller to for instance, quickly search for a call by single button clicks or by input filter(s).

The invention and its particular features and advantages will become more apparent from the following description considered with reference to the accompanying drawings.

### BRIEF DESCRIPTION OF THE DRAWINGS

FIG. 1 is a block diagram of one advantageous embodiment of the present invention.

FIG. 2 is a block diagram of another advantageous embodiment of the present invention according to FIG. 1.

FIG. 3 is a block diagram of still another advantageous embodiment of the present invention according to FIG. 1.

FIG. 4 is an illustration the software display for the audio recording device according to FIG. 1 in the icon mode.

FIG. 5 is an illustration the software display for the audio recording device according to FIG. 1 in the “small footprint” mode.

FIG. 6 is an illustration the software display for the audio recording device according to FIG. 1 in the “full size” mode.’

FIG. 7 is an illustration of still another advantageous embodiment of the audio recording device software display showing the bookmarks feature.

FIG. 8 is an illustration of yet another advantageous embodiment of the audio recording device software display showing the comment feature.

### DETAILED DESCRIPTION OF THE DRAWINGS

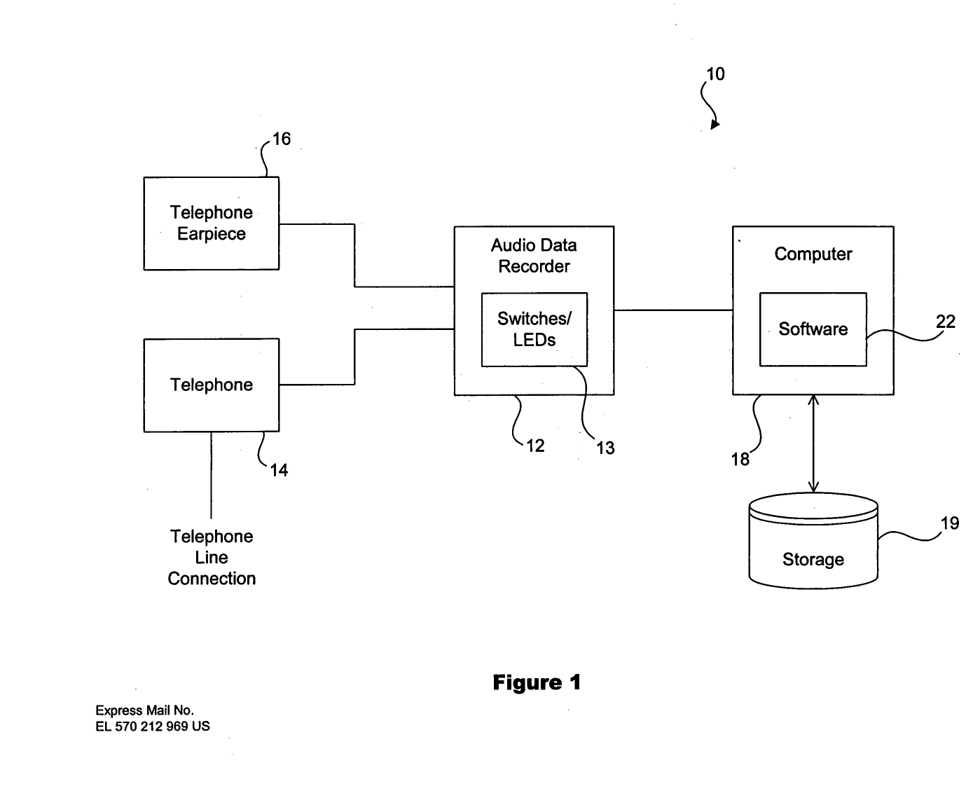

FIG. 1 illustrates audio data recording system 10 including audio data recorder 12 which is shown in a “stand alone” mode being connected directly to a telephone 14 and telephone earpiece 16. The telephone is connected to a telephone line to send and received audio signals. Audio data recorder 12 is further connected to a computer 18 via for instance, a USB connection 20. Audio data recorder 12 may in one advantageous embodiment, be powered by computer 18 through the USB connection 20. Software 22 is installed on computer 18 for management and manipulation of recorded audio files.

The computer 18 may be or include, for instance, a personal computer running the Microsoft Windows® 95, 98, 2000, Millenium®, NT®, Windows CE®, Palm® OS, Unix®, Linux®, Solaris®, OS/2@, BeOS®, MacOS® or any other operating system or platform. Computer 18 may also be or include any microprocessor-based machine such as for instance, an Intel® x86-based device or Motorola 68K or PowerPC device, microcontroller or other general or special purpose device operating under programmed control.

It should be noted that while audio data recorder 12 is shown in FIG. 1 as having only one input, audio data recorder 12 may include a plurality of inputs for capturing audio signals, which may in one embodiment comprise analog audio signals. Once gathered by audio data recorder 12, the audio signal is converted to a digital signal via an A/D converter (not shown) in audio data recorder 12, is compressed and formatted into a standard audio format, and is finally transferred to computer 12 for storage and/or further manipulation. The audio data recording system 10 may also perform the reverse function of taking a formatted digital file, transferring it through for instance, the USB connection from computer 18 to the audio data recorder 12, which in turn converts the digital signal to an analog signal that may be played through telephone earpiece 16. Alternatively, the audio data recording system 10 may further be utilized to play a recorded digital file through speakers (not shown) provided with computer 18. It is still further contemplated that audio data recorder 12 may be utilized to record digital signals and convert them to PCM and wave format.

Audio data recorder 12 may also comprise one or more switches/LEDs (Light Emitting Diodes) 13. In one advantageous embodiment, five (5) LEDs are utilized in connection with four (4) switches such as is illustrated in FIG. 1. One of the LEDs may for instance, indicate when the audio data recorder 12 is powered, i.e. when the audio data recorder 12 is connected to computer 18 via for instance, the USB port. It is still further contemplated that audio data recorder 12 may be provided with circuitry and/or software to detect and report on any disconnection of audio data recorder 12 from for instance, computer 18, telephone earpiece 16 and/or the telephone line.

Still further, the switches/LEDs 13 may be used to operate audio data recorder 12, with the remaining four switches/LEDs being paired to each other respectively such that they provide a visual indication as to which switch has been activated.

The four switches may include the following functionality: (1) Record Room—which is used to record audio data directly picked up by the device, such as for instance, a conversation taking place in the vicinity of audio data recorder 12; (2) Record Phone—which may be used to record a telephone conversation; (3) Play/Stop—which may be used to playback an audio data recording; (4) FF/Rewind/Scroll—which will allow a user to review the recording, where the push button may be configured such that for instance, pushing the left side of the button will rewind or pushing the right side of the button will FF and/or scroll the recorded messages.

While manual switches may be provided for functionality, it is further contemplated that audio data may be automatically recorded based on voice recognition or that a location may be monitored and automatically recorded and/or set an event such as setting off an alarm at a remote location.

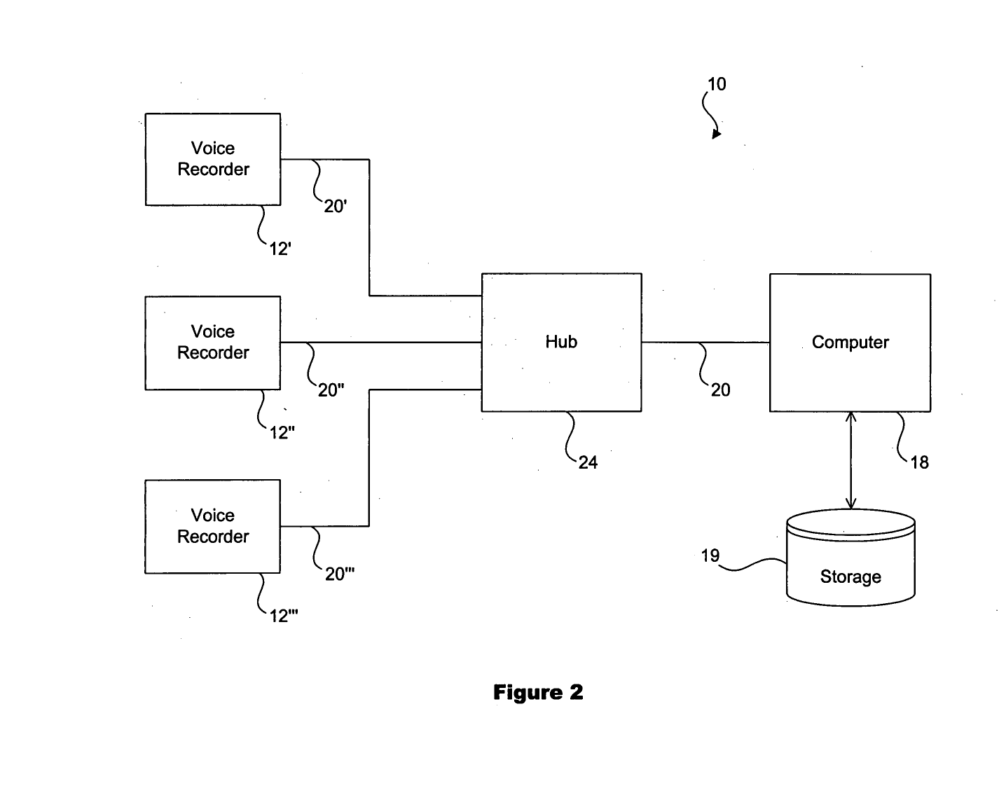

FIG. 2 illustrates an alternative embodiment of audio data recording system 10. In this embodiment, audio data recording system 10 is configured in “hub mode” in which audio data recording device 12 is connected to computer hub 24 rather than directly to the computer 18 itself. The system 10 further includes multiple audio data recorders (12′, 12″, 12′″) connected to computer hub 24 via USB connections (20′, 20″, 20′″). Computer hub 24 is in turn connected to computer 18 via USB connection 20 as previously described in connection with FIG. 1. It should be noted that while three (3) audio data recorders are illustrated, any number of audio data recorders may be connected as desired.

In this embodiment, it should be noted that recorded files may be stored for instance, in individual user folders on computer 18 with each audio data recorder (12′, 12″, 12′″) operating independent from each other. It may further be desired by the user to record and play multiple audio data files, such as conversations, simultaneously.

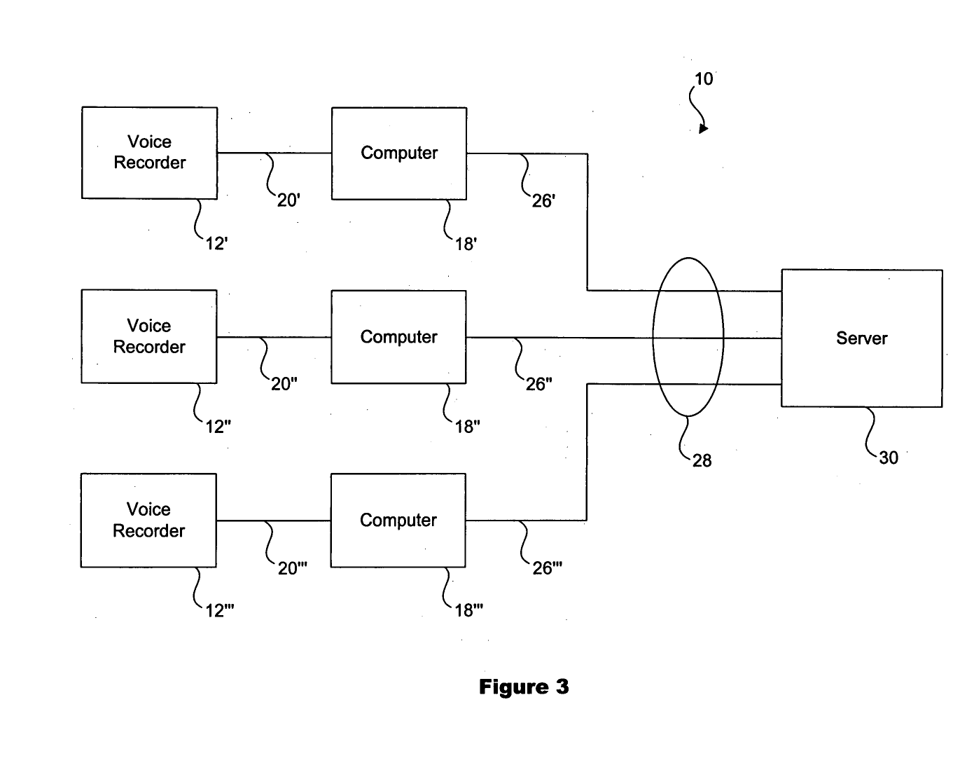

FIG. 3 illustrates another alternative embodiment of audio data recording system 10 configured in “enterprise mode” where a plurality of audio data recorders to be connected to a plurality of individually networked computers. In this embodiment, audio data recording system 10 comprises audio data recorders (12′, 12″, 12′″) connected to computers (18′, 18″, 18′″) via USB connections (20′, 20″, 20′″). Computers (18′, 18″, 18′″) are in turn connected to server 30 via network connections (28′, 28″, 28′″). It should be noted that while three (3) voice recorders and computers are illustrated as connected to server 30, any number may be connected as desired.

In this embodiment, it may be advantageous to centrally locate the recorded files from the various audio data recorders (12′, 12″, 12′″) allowing a system administrator maximum capabilities for reviewing and organizing the recorded information. The system administrator may for instance, search and listen to all recordings by date, time, client, agent, type of call book mark or comments added to the recorded file. A system administration screen further provides the ability to monitor the status of each device. It is further contemplated that the system may utilize any database such as an SQL database configuration to track and organize the recorded conversations. A further function that may be provided is the ability to transfer files to a central server via for instance a TCP/IP connection. The TCP/IP communication may be used to maintain a real time status of each of the voice recorders within the network.

Network connections (28′, 28″, 28′″) joining the computers (18′, 18″, 18′″) and the server 30 may be or include any one or more of, for instance, the Internet, an intranet, a LAN (Local Area Network), a WAN (Wide Area Network) or a MAN (Metropolitan Area Network), a frame relay connection, an Advanced Intelligent Network (AIN) connection, a synchronous optical network (SONET) connection, a digital T1, T3 or E1 line, Digital Data Service (DDS) connection, DSL (Digital Subscriber Line) connection, an Ethernet connection, an ATM (Asynchronous Transfer Mode) connection, FDDI (Fiber Distributed Data Interface) or CDDI (Copper Distributed Data Interface) connections.

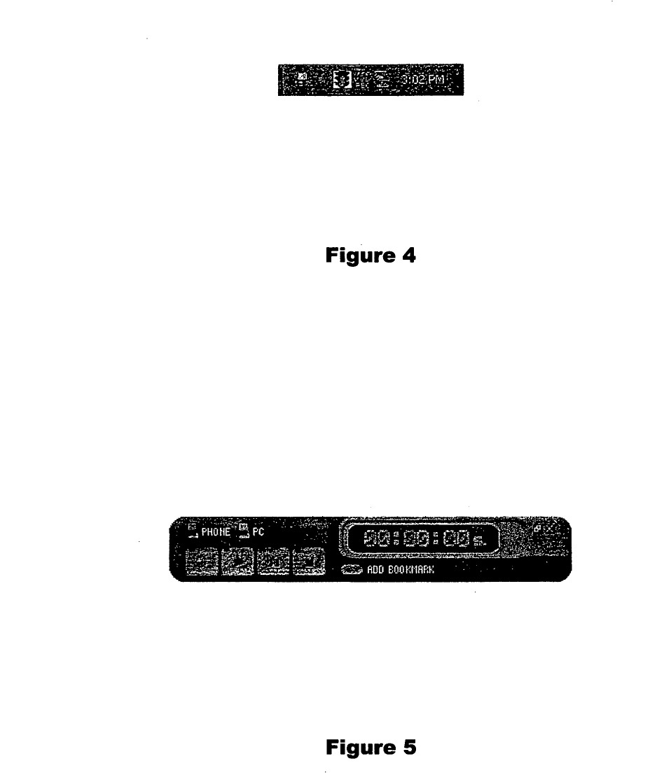

Referring now to FIGS. 4-6, audio data recording system 10 comprises three different interfaces variously illustrated in FIGS. 4, 5 and 6 respectively.

For instance, FIG. 4 is a view of the interface of software 22 operating on computer 18 according to FIG. 1. In this embodiment software 22 is operating in the “systray” mode and is displayed as a minimized icon that may reside on a computer desktop.

In the normal wait state the “systray” icon may be illustrated as yellow in color. Alternatively, in a record condition the color of the icon may change for instance, red. While during playback mode the icon may be shown as green.

FIG. 5 is a view of the interface of software 22 according to FIG. 1 operating in the “small footprint” mode and is displayed with a minimal number of functions available to the user including the ability to select record and/or play modes, and record and/or play files with reviewing capabilities.

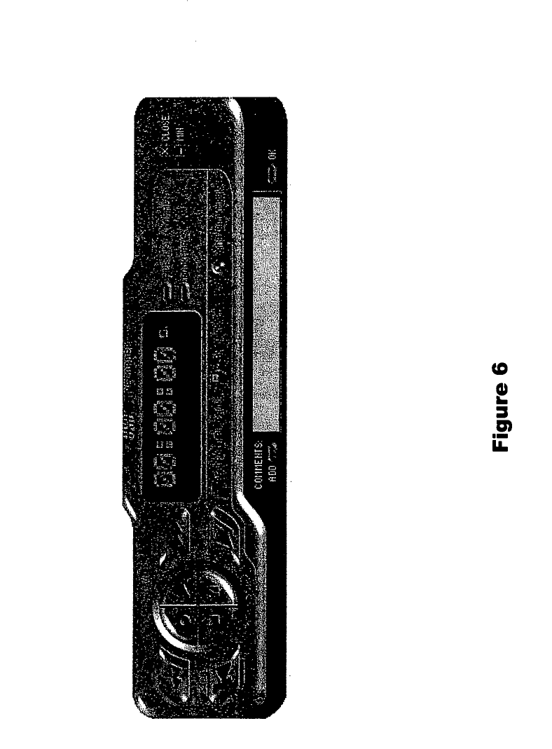

FIG. 6 is a view of the interface of software 22 according to FIG. 1 operating on computer 18 in the “full size” mode and is displayed with a maximum number of functions available to the user so as to adjust configurations and to review and organize the recordings.

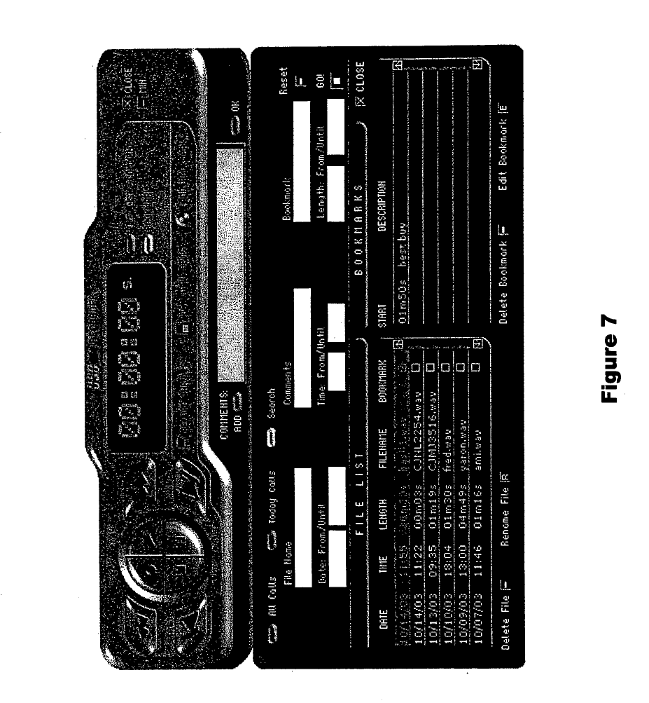

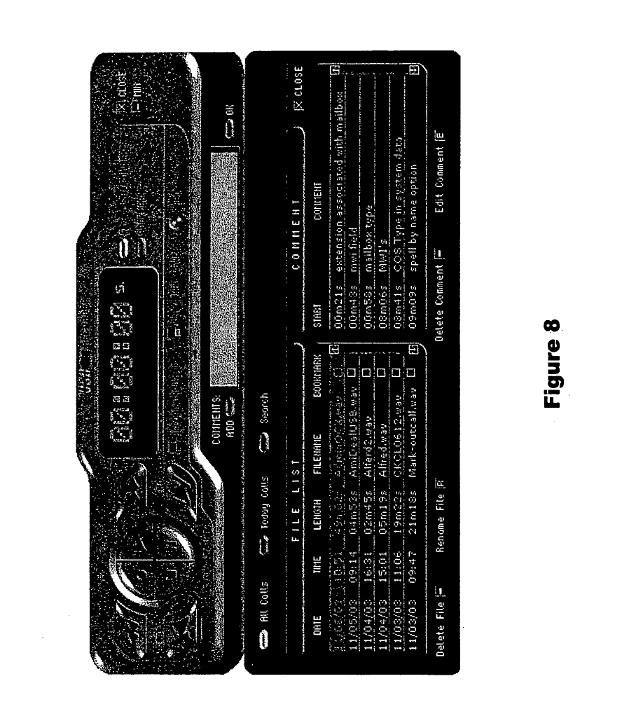

The software 22 may still further allow the user to set comments and bookmarks on the recordings for quick and easy retrieval to specific locations of the recordings as illustrated in FIGS. 7 and 8. A user may review a recording and generate a bookmark that references a specific location within a specific recording. The user may then input a written description for the bookmark to provide a key or note relating to the bookmark.

FIG. 7 is a view of the interface according to FIG. 6 further including a file list shown on the lower left, and a bookmark list shown on the lower right. In this embodiment software 22 is operating in the “full size” mode and further displays an example of bookmarking a recording. For instance, in this example a bookmark has been placed within the recording at exactly 1 minute and 50 seconds into the recording and is referenced as “best buy” shown on the bookmark list.

FIG. 8 is a view of the interface according to FIG. 6 further including a file list shown on the lower left, and a comment list shown on the lower right. As in FIG. 7, in this embodiment software 22 is operating in the full size mode and displays various examples of attaching comments to recordings. For instance, in this example a number of comments have been attached to the selected recording.

A comment, like a bookmark, allows the user to reference a specific location within a recording but allows the user more space to describe the comment. The software allows a caller to for instance, quickly search for a call by single button clicks or by input filter(s).

Although the invention has been described with reference to a particular arrangement of parts, features and the like, these are not intended to exhaust all possible arrangements or features, and indeed many other modifications and variations will be ascertainable to those of skill in the art.

1. An audio data recording system comprising:
an audio data recorder for receiving an audio signal and transmitting a digital audio signal;
a telephone port for connecting to a telephone line;
a telephone earpiece port for connecting to a telephone earpiece;
a computer, connected to said audio data recorder;
a storage accessible by said computer for storing the digital audio signal; and
software, operating on said computer for receiving and manipulating the digital audio signal.

2. The audio data recording system according to claim 1 wherein said audio data recorder is connected to said computer via a USB connection.

3. The audio data recording system according to claim 1 wherein the received audio signal is an analog audio signal and said audio data recorder further comprises and A/D converter.

4. The audio data recording system according to claim 1 wherein said audio data recorder further comprises visual indications as to a current mode said audio data recorder is currently operating in.

5. The audio data recording system according to claim 4 wherein the visual indications comprise LEDs.

6. The audio data recording system according to claim 4 wherein the currents modes are selected from the group consisting of: Record Room, Record Phone, Play/Stop and FF/Rewind/Scroll.

7. The audio data recording system according to claim 1 wherein said software includes a visual interface.

8. The audio data recording system according to claim 7 wherein the visual interface presents recorded audio data files in the form of a list.

9. The audio data recording system according to claim 8 wherein said software allows a user to append comments to a recorded audio data file.

10. The audio data recording system according to claim 9 wherein the appended comments reference a particular portion of the audio data file.

11. The audio data recording system according to claim 9 wherein the visual interface presents the appended comments in the form of a list.

12. The audio data recording system according to claim 1 wherein said audio data recorder begins recording the received audio data when a human voice is detected in the received audio data.

13. An audio data recording system comprising:
at least two audio data recorders for receiving audio signals and transmitting digital audio signals respectively;
a computer hub, connected to said at least two audio data recorders;
a computer, connected to said computer hub;
a storage accessible by said computer for storing the digital audio signals; and
software, operating on said computer for receiving and manipulating the digital audio signals.

14. The audio data recording system according to claim 13 wherein said at least two audio data recorders are connected to said computer hub via a USB connection.

15. The audio data recording system according to claim 14 wherein said computer hub is connected to said computer via a USB connection.

16. A method of recording audio data comprising the steps of:
connecting an audio data recorder to a telephone line;
connecting a telephone earpiece to the audio data recorder;
receiving an audio data signal having a first audio data format;
converting the audio data signal having the first audio data signal format to a second audio data signal format;
connecting the audio data recorder to a computer;
transmitting the converted audio data signal to the computer; and
storing the converted audio data signal on a storage accessible by the computer.

17. The method according to claim 16 wherein the audio data recorder is connected to the computer via a USB connection.

18. The method according to claim 16 further comprising the steps of presenting the converted audio data signal to a user with a visual indication.

19. The method according to claim 18 wherein the visual indication comprises a list.

20. The method according to claim 16 further comprising the steps of:
transmitting the converted audio data signal from the computer to the audio data recorder;
converting the converted audio data signal having the second audio data signal format to an audio data signal having the first audio data signal format; and
playing back the audio data signal having the first audio data signal format for a user to listen to.
